(19) United States
(12) Patent Application Publication
(10) Pub. No.: US 2005/0080817 A1
(43) Pub. Date: Apr. 14, 2005

(54) Methods and systems for improving productivity in organizations by managing and optimizing the organizational entropy and the maximum management decision rate

(76) Inventor: Richard H. Janow, South Orange, NJ (US)

Correspondence Address: DR. RICHARD H. JANOW, 514 NORTH WYOMING AVENUE, SOUTH ORANGE, NJ, 07079, US

(21) Appl. No.: 10/682,818

(22) Filed: Oct. 10, 2003

(51) Int. Cl. G06F 17/00

(52) U.S. Cl. 707/104.1

(57) ABSTRACT

The consumption of decision information by an organizations' own structures results in an upper limit on the average sustainable per capita decision rate. Individual decision-makers insert management decisions into the control network and expect to eventually receive decisions back from it. The organizational entropy and the related maximum decision rate measure extra information used to support the partitioning of tasks to decision-making nodes. The invention teaches how to quantify organizational entropy, using information theory, and applies the new principles to tools for managing and re-engineering organizations in order to improve productivity in performing knowledge-intensive tasks. The embodiments are quantitative methods of choosing efficient organizational structures and sizes matched to the decision complexity. Some preferred methods are OR optimization techniques that incorporate organizational entropy into their cost functions and also rules or heuristics for applying broad organizational re-engineering strategies that managers can use to improve performance.

### CROSS-REFERENCE TO RELATED APPLICATIONS

Not Applicable.

### STATEMENT REGARDING FEDERALLY SPONSORED R & D

Not Applicable.

### BACKGROUND OF THE INVENTION

1. Field of the Invention

This invention is applicable to the management and re-engineering of organizations in order to improve their productivity as they execute decision-intensive and knowledge-management tasks. The invention can be applied to all kinds of organizations that function as control networks, said organizations consisting of a plurality of human decision-making nodes together with a plurality of associations between said nodes that carry decisions and other actionable information from node to node. Examples include commercial business firms, governments, communities and tribes, and military command, control, and battle management entities. The invention may improve the competitiveness of business firms in some commercial markets.

The invention applies novel, quantitative measures of organizational entropy and its impact on productivity to the problem of choosing an organizational structure that uses decision-makers' capacity most efficiently.

The decision-making nodes are human beings in most current organizations. The nodes may also include a plurality of automated intelligences making decisions in a manner such that they replicate the functions of the human decision-making nodes. The invention pertains also to organizations composed wholly or in part of a plurality of said automated intelligences, applying specifically to the decision-making behavior rather than the gross computing capability of said automated intelligences.

2. Related Prior Art

People in large organizations who work with decisions and knowledge often perceive reduced efficiency and effectiveness compared with small organizations. For example, an individual who asks his firm to assimilate his work and make decisions based on it may have to wait an inordinately long time for a response, even when the issues to be decided seem straightforward. Sluggish response becomes more pronounced as organizations grow larger.

Individuals can become frustrated by perceived impediments and assign them to bureaucracy, resistance to fresh initiatives, turf protection, complacency, etc. Individuals collaborating on tasks with others may find that the system cannot absorb and act on decisions fast enough to keep up with their own pace. They will often experience frustration, avoid collaboration, select incompatible objectives, and end up working at cross-purposes as they give up on coherent action, causing wastage of valuable human resources and delay in meeting schedules and objectives. Knowledge managers and customers finding that the organization cannot keep up with them achieve less than their maximum productivity.

Those experienced in the art of management commonly recognize these kinds of phenomena in large organizations but the prior management art lacked the quantitative principles, methods and systems provided by this invention. Management tools, including methods of choosing efficient organizational structures and sizes, methods for optimizing costs and expenses, knowledge management practices, staffing criteria, etc have been deficient in that these methods and tools do not incorporate the role of decision information that is consumed by the structures of the organizations themselves and said management tools have not provided quantitative criteria based on said structural information.

As a result, efforts to improve the performance and competitiveness of organizations through re-engineering and reorganization efforts, or through mergers, multi-vestitures, and acquisitions have been guided by haphazard, ad hoc methods, and have often been unsuccessful with respect to improving the efficiency of decision-based, knowledge-management activities.

This invention teaches that there is a fundamental upper limit on the average per capita decision rate that an organization can sustain, depending inversely on the decision complexity. Individuals experiencing the effects associated with large organizations may actually be over-running their organization's ability to keep up with their own decision processing delivered through the usual organizational channels. The organizational entropy taught by the invention is a part of the decision complexity and it measures extra decision information needed on account of the organizations pattern for assigning tasks to decision-making nodes. The organizational entropy therefore makes average decision complexity become partly a function of the organizations own size.

The invention's embodiments in methods and systems include quantitative techniques that can be applied by those of ordinary skill in operations research and management to optimize an organization's efficiency. The methods and systems can be used also as rules or heuristics in applying broad strategies for improving organizational performance that are known to those of ordinary skill in management but have heretofore been used without benefit of quantitative rules or heuristics to guide their application.

The patent literature revealed no prior art directly related to the claims of the current invention.

The management literature shows numerous instances of the application of optimization techniques to financial criteria associated with operating an organization. But there are no prior applications of the principles of this invention, namely the use of organizational entropy and the maximum management decision rate as taught below, to the problems of reengineering organizations and optimizing the productivity of knowledge-management tasks.

There are examples of the use of physical entropy to control manufacturing processes (e.g., U.S. Pat. No. 6,415,272) and Shannon entropy in quantum computing (e.g., U.S. Pat. No. 6,578,018), but these do not incorporate an information-theoretic entropy related to the topology of a decision network, and they do not pertain to improving the productivity of decision-makers that are managing human organizations or organizations composed in part of automated decision-making nodes.

In the parallel processing computer literature there is a rule called “Amdahl's Law” [see reference 6] known to those of ordinary skill in the computing art. It predicts an upper limit on processor efficiency but is otherwise inapplicable to the principles of this invention inasmuch as (1) the Amdahl's Law limit pertains to the specific content of algorithms mapped onto a parallel processor rather than to the topology of the network and (2) Amdahl's Law is restricted to computer systems and does not pertain to the management of human organizations and institutions.

### SUMMARY OF THE INVENTION

The invention rectifies deficiencies in the prior art by providing means to select organization structures that can improve the efficiency of knowledge managers. The “knowledge managers” in an organization include those performing management decision-making related to governance of said organization and also those performing complex cognitive work where there is continual need to make decisions that interpret, assess, and synthesize data and intellectual property.

Practitioners can use the invention by applying the formulas and rules taught below to evaluate the current and proposed organizational structure and knowledge management systems for an organization. Practitioners may then change the structure of the organization to increase the per capita decision rate (efficiency) by lowering the decision complexity function and the organizational entropy. A practitioner can estimate or do a detailed evaluation of the organizational entropy and/or the maximum decision rate (also called the maximum management decision rate) in relative or absolute terms and then use these quantities as part of a cost function or as an informal guide in methods that improve the organization's efficiency. The organizational entropy and maximum decision rate functions are defined in the section “Detailed description of the invention” that follows below. The metrics introduced there may be used for example as parts of the “cost functions” known to those of ordinary skill in optimization and linear or non-linear programming methods.

The means provided by the invention can detect and prescribe specific changes in the organizational structure and knowledge management practices followed within organizations that will improve productivity and lower the costs associated with knowledge-based work. More specifically, the invention provides managers and others with rules and quantitative tools for adjusting the structure and knowledge-management systems in accordance with the principle of lowering or minimizing the organizational entropy. The invention therefore provides means for quantitatively improving the efficiency of business firms and other organizations. Practitioners of ordinary skill in the art can routinely use the invention as a management tool.

1. Principal Teachings

The invention provides a definition of organizational entropy and provides formulas and methods for evaluating it. The organizational entropy is related to the decision complexity as defined in the next section. The invention further teaches that there is a maximum rate at which an organization can assimilate and use decisions made by individuals within it who are working with knowledge. The invention provides formulas and methods for evaluating said maximum decision rate, symbolized by M(n) in the sections below.

The per capita maximum decision rate measures efficiency for performing knowledge-intensive tasks. When organizational entropy grows, the maximum sustainable per capita decision rate decreases, favoring small organizations for knowledge-management tasks that are sensitive to the efficient use of human resources. As organizations grow they tend to use their intellectual capital less efficiently (assuming other variables are constant) because the connectivity between decision nodes grows, thereby increasing the organizational entropy. In one embodiment of the invention, a model organization consists of n decision nodes and is “fully connected” as described below. The maximum per capita decision rate scales for this case as 1/log₂(n), illustrating the decrease with size. The maximum per capita decision rate is symbolized by μ(n) in the sections below.

The invention teaches that growth in an organization's size can result in impaired productivity among knowledge managers unless there is continual, conscious restructuring designed to avoid some of the entropy effects. Large organizations develop structural dis-economies of scale regarding the efficiency with which they use intellectual capital and they need to re-engineer their structural forms to match the inherent decision complexity of tasks that they engage, especially in markets where competitiveness is closely linked to efficiency.

The invention teaches that the smallest size organization that has the resources to handle a task is preferable from an efficiency point of view.

The invention also teaches that there is an additional, distinct saturation effect that triggers if a threshold corresponding to individuals's decision throughput limits is reached. There is thus a “window” within which organizational efficiency can be improved by “sparsifying” the links in the decision network in order to reduce entropy, inasmuch as “sparsification” may cause the burden of selecting and forwarding decision-intensive information to fall on fewer individuals and may therefore trigger said saturation effects.

2. Applicability

The invention is applicable to organizations and sub-units of organizations that are knowledge-driven, meaning that the tasks worked on require decisions of many kinds to be made continuously in the course of manipulating information or intellectual property.

The invention may advantageously be used by commercial organizations to increase their competitive advantage in markets where knowledge processing efficiency has the dominant impact on product economics. The invention's use, for example, can help large organizations minimize intellectual labor costs and thereby regain competitive advantage lost to small ones. The per capita maximum decision rate is typically higher for small organizations, favoring them in competitive situations when knowledge efficiency is the primary cost driver affecting product pricing, quality, and timeliness. When a commercial firm's output is intellectual labor, services, or property of some kind, organizational entropy becomes a production productivity driver and small firms may gain a competitive advantage.

Commercial firms that are knowledge-driven can benefit from the invention, including those in many fields such as consulting, engineering, creative design, software and product development, publishing, insurance, and bureaucracies of all kinds. In non-profit organizations and government agencies, the invention provides the same kind of efficiency benefits.

The invention may be advantageously used as well in military systems for improving the speed and productivity of command and control, intelligence and sensor fusion, and real-time battle management functions. These functions depend for military success on the rapid execution of many complex decisions by networks of skilled human decision-makers, who are a limited resource.

The invention applies also to organizations wherein human decision nodes are interconnected with computer processor decision nodes (automated intelligences) or are replaced entirely by computer decision nodes (automated intelligences), in each case executing decision-making programs stored thereon. The entropy and maximum decision throughput can be computed using principles of the invention in order to improve the per processor computing efficiency by reorganizing the distribution of tasks and the interconnection topology of the decision network connecting said individual processors.

3. Embodiments

The invention's embodiments are based on prescriptions for computing the organizational entropy and the maximum management decision rate and related concepts taught in the section of this specification called “Detailed description of the invention”. Some preferred embodiments are mentioned here and in the section cited above.

One embodiment of the invention entails constructing a detailed model of the organizational structure along with models or templates for the “dit” rates (basic decision-item rates) associated with the decision paths and estimates of probabilities associated with said decision paths, in accordance with the formulas and rules of the invention. The maximum decision rate and/or the decision complexity so computed are then used as cost functions in a minimization or maximization procedure such as the so-called “simplex” method, known to those of ordinary skill in operations research. Some constraints are held constant, such as the number and type of decision nodes. Advantageously, such modeling is performed on computing machinery.

One means for finding structures with reduced organizational entropy is “sparsification”; that is, the process of discarding decision paths in order to limit the number and character of node-to-node decision transfers. In extreme cases “sparsification” can result in sub-organizations dedicated to certain tasks that operate autonomously or with a minimal set of decision interfaces to other entities in the parent organization.

In embodiments of sparsification, an organization of n knowledge workers may be split into m smaller sub-units with some small number of decision paths interconnecting interfacial decision nodes in said smaller sub-units. After evaluating the relative per capita maximum decision rates for knowledge-tasks, the value of m can be selected. Rules or formulas cited in the section cited may be used to evaluate said comparative values of the maximum decision rate.

It may be necessary to consider scale economies aside from those affecting knowledge-intensive activity that grow with organizational size. Such other scale economies may include manufacturing efficiency, access to capital sources, and mass purchasing power.

There are many other embodiments of the invention, some of which are introduced below.

### DRAWINGS AND FIGURES

Not Applicable

### DETAILED DESCRIPTION OF THE INVENTION

1. Introduction

Knowledge managers principally work on decision-intensive tasks that are often an organization's product as well as the means of controlling the organization itself. These are all lumped together and called “management decisions” in the discussions that follow.

Organizations are a species of control system in which the decision network (perhaps several of them) has humans as nodes [1]. Individual decision-makers use the control network they are in as a communication channel: they insert management decisions into it and expect to eventually receive decisions back from it. The network has some maximum decision rate it can support; if managers try to exceed it, their work may be dropped altogether and responses may be delayed or inappropriate. The flows of management- and application-related decisions are reminiscent of flows of symbols in a communication channel.

Ordinary communication channels have capacity limits and the key events are the transmission of symbols (such as letters of the alphabet) rather than decisions. Claude Shannon [2] developed information theory for communication systems and perhaps most notably recognized a form of entropy as a quantifier for information.

The organizational entropy that is introduced below contributes to the average decision complexity (choice), just as entropy for a communication channel measures the average information content (bits per symbol) of symbols transmitted over it. But the organizational entropy is due to the structure of the organization; it grows as a decision network grows even if the complexity of the tasks themselves remains unchanged. As organizations grow, often having to take on increasingly complex tasks, the decision structure adds nodes and it partitions functions among many decision makers in order to “divide and conquer” problems. That added structure increases the network entropy and adds to the decision complexity.

One key aspect of the invention is knowledge that the organizational entropy grows fast enough to more than offset growth in the total of individuals' capacities for making basic binary decisions. There emerges a fundamental upper limit on the total management decision rate that grows slower than linearly with the number of nodes in an organization. The maximum per capita management decision rate therefore actually shrinks as the number of decision-makers in the network grows. The shrinking limit on per capita decision throughput may be reached and felt as impaired productivity.

Another aspect of the invention is realization that the throughput limit is intrinsic to the control network and is emphatically not related to congestion on any physical communication networks that may be present. The throughput limit has in principle been operating as long as humans have formed groups and divided up roles. The invention is the first recognition of this limit and method for incorporating it into the management of organizations.

These aspects of the invention highlight its potential to help businesses, for example, be more efficient and competitive in markets that involve managing knowledge and decisions. To be competitive, a growing organization needs to be concerned about adding to its management decision load through excessive structure, and it may need to modify its organization and knowledge-sharing resources to control structural entropy.

2. A Model for Decision Processes

2.1. Management Decisions and “Dits”

Management decisions are reducible in principle to binary decision elements [1]. These quanta of actionable decision information play a role in decisions and cybernetics analogous to that of “bits” in classical information theory, and so the term “dits” is used here to emphasize the parallel. Beer [1] pointed out that a dichotomous classifier could in principle generate binary representations for decisions (in terms of “dits”). A human (or a coding device) might parse statements to find actionable content, develop a set of (decidable) symbolic logic statements, map them onto a binary tree, and then code them as a string of “dits”1. Although feasible this task would clearly be somewhat tedious unless it can be automated. Management decisions are fairly high level in that they are composed of many “dits” (independent choices)-reminiscent of communication symbols, which are composed of some number of bits.
¹This is analogous to compression of a symbol set in information theory.

An important aspect of the invention is the absence of a direct relationship between the way a decision is represented via a sequence of “dits” and representations of the decision as symbol and bit strings for transmission. Dits are “actionable”, not just perceptual. For example, bitmap graphics and the like may require a huge number of bits but have little or no actionable content. A message authorizing a military attack might be just a few bits long but have a huge decision complexity (many “dits”).

The complexity of management decisions (i.e., their average length in “dits”) says nothing at all about their importance to the organization. It measures ultimately the amount of thought they require.

2.2. The Upper Limit M(n) on the Maximum Management Decision Rate:

The maximum management decision rate for an organization, denoted by M(n), is a quantity of great usefulness. An organization is regarded as a network of n decision nodes: knowledge workers who create, consume, and communicate actionable information related to the organization's activities.

M(n) is simply the quotient of the total dit capacity R(n) for the organization divided by a function A(n) that represents the average decision complexity and has dimensions of dits/decision:

$$M ( n ) ≡ \frac{R ( n )}{A ( n )} \qquad ( 1 )$$

A(n) includes contributions from the inherent complexity of tasks themselves, and also an entropy-like component due to the decision network structure. The entropy component is a kind of Shannon entropy, in that it represents information; but the information represented is measured by elementary decision choices (“dits”) faced by a human or other decision-maker rather than by general-purpose bits representing a symbol to be transmitted.

One aspect of the invention is: the entropy of the entire organization limits the decision rate at node i, rather than just the contribution due to decisions at node i alone, which is smaller by roughly a factor of n. This makes intuitive sense inasmuch as the individual nodes are working on pieces of tasks that were distributed to the nodes.

2.3. The Maximum “Dit” Capacity R(n)

Each of the n people in an organization can have a decision path to any of the remaining n−1 others, and so R(n) scales as n.(n−1), approximating n² for large n. For node i, Rᵢ(n) represents the total capacity involving as many as n−1 destination nodes. Each such linkage is represented by R_{0i,j} ρ_{i,j} (with dimensions “dits”/unit time). The factors R_{0i,j} are maximum dit rates between pairs of decision-makers and may vary for each path. They depend on the people at either end of the paths. The coefficients ρ_{i,j} measure the relative probability of choosing each decision path and range from 0 to 1.

The maximum “dit” capacity is a sum over all the sources and destinations for decisions:

$$R ( n ) = {\sum }_{i = 1}^{n} {R}_{i} ( n ) \\ = {\sum }_{i = 1}^{n} {\sum }_{j = 1 , j \neq 1}^{n} {ρ}_{i , j} {R}_{0 i , j} \leq {\sum }_{i = 1}^{n} {D}_{i} \qquad ( 2 )$$

When all paths are fully open all the time, ρ_{i,j} equals 1 for all values of the indices. Modeling the dit capacity function for a large organization in principle requires a complete map of who is connected to whom with values for the dit rates. But actual embodiments of the invention may reduce the amount of labor required by utilizing approximations as embodiments of the invention.

The extreme right hand side of Equation (2) following the inequality recognizes that individual decision-makers can become saturated. Each person can think and make basic binary decisions (“dits”) at some maximum rate Dᵢ (in dits/unit time) that depends on personal and resource characteristics. The binary dit rate Dᵢ might support a few complex or many simple management decisions.

When all of the nodes in an organization reach saturation (by having too many paths to interact with, for example), the right hand inequality above takes over as the upper limit on the “dit” rate, which then grows proportionally to n rather than n². This could happen for example if an organization grows very large without reorganizing to limit the paths and dit rates per knowledge worker. The workload must be further partitioned onto a larger staff (increasing n) accompanied by structural change. Saturation can produce a dramatic collapse of productivity, as discussed below.

2.4. Organizational Entropy

Like physical entropy, organizational entropy is an extensive quantity: it grows with the size of the decision network. The connection between entropy, information, and choice has been known for a long time and it is reasonable for decision processes to have an associated entropy.

As early as 1894, physicist Ludwig Boltzmann [3] observed that the entropy of a physical system is related to “missing information” inasmuch as it counts the number of alternative microscopic (“degenerate”) states of a physical system that might be chosen consistent with a single macroscopic state (set of observables). The entropy grows with the size of the phase space volume that a system can occupy. When all phase space cells (microscopic system states) are equally probable and the entropy is a maximum. The system is then highly disordered and it takes a lot of information to specify which of the microscopic states it is in. By contrast, the state of a highly ordered system (say, a solid at absolute zero temperature) has low entropy and takes comparatively little information to specify.

When Shannon [2] quantified information for communications, he used the notion of choice as a key insight. In information theory, the freedom to choose a symbol from a symbol set led to a definition of information using a mathematical function identical to that of statistical entropy. Whenever a symbol sequence is highly predictable, choice is small and little information is conveyed.

The choice notion is an aspect of the invention in that it applies to destinations for actionable information in an organization. Entropy for organizations measures the “degeneracy” (choice) in the number of alternative decision network topologies that are possible within the organizational structure: a subset of these states is used to perform particular management and knowledge-intensive tasks. When the range of decision network states is large so is the entropy; the organization is then also something of a general-purpose tool. Conversely, when organizational entropy is small, the organization is likely to do a prescribed set of specialized tasks efficiently and others not at all. High organizational entropy is the price of having the capability to execute a range of complicated, multi-person decision tasks; that capability necessarily impairs efficiency when doing simple tasks for which a multi-purpose structure may be over-kill.

2.5. The Decision Complexity A(n)

The decision complexity A(n) is the average number of “dits” needed to represent the set of management decision tasks. It is a sum over contributions Aᵢ(n) from each of the n decision nodes. Each contribution is the product of the intrinsic complexity A₀ᵢ of the tasks that node i performs and a factor Hᵢ that measures the entropy of the decision network that node i sees.

An expression for the entropy contribution is derived via the following argument (see also Hamming's [4] discussion of Shannon entropy for a communication channel) applied to a network of decision makers. The i'th person chooses one of the remaining n−1 people in the organization every time he issues a decision to the network. Let pᵢ(j) be the conditional probability that person i chooses person j as his target.

If the destination is known in advance there is no surprise and no information is needed to know whom person i hands off decisions to. One of the pᵢ(j) is then equal to 1 and all the other probabilities are zero. If the probabilities are all equal (and small if n is large) then the “surprise” when one recipient is actually picked is at it's maximum and that choice carries significant information. The information needed to pick a recipient is thus related to the inverse of the probability pᵢ(j) for making that choice.

When two decision recipients are chosen independently, the information associated with the joint event should simply be the sum of the information for each separately, viz:
Info[(sᵢ,sⱼ) and (sᵢ,sₖ)]==Info(sᵢ,sⱼ)+Info(sᵢ,sₖ)

In the above, the notation (sᵢ,sⱼ) represents the event in which source i chooses recipient j. A logarithmic function² uniquely satisfies all these requirements, viz:
²With base 2 logarithms, the logarithm of a number is simply the number of binary integers (bits) needed to represent it. One can switch between base 2 and natural (base “e”) logarithms without losing generality, apart from the constant 0.6931 which is the natural logarithm of 2, viz.:

log₂(x)=logₑ(x)/logₑ(2)=logₑ(x)/0.6931
Info(sᵢ,sⱼ)=log₂(1/pᵢ(j))=−log₂(pᵢ(j))

Zero information is involved when there is no surprise inasmuch as the probability equals unity and log₂(1)=0.

The expected value for the entropy hᵢ(j) (information in “dits”) associated with the pair (sᵢ,sⱼ) is just the conditional probability of choosing j multiplied by the information associated with the choice, i.e.,
hᵢ(j)=−pᵢ(j)log₂(pᵢ(j))

The entropy Hᵢ for all the destinations that person i communicates with is just the sum of hᵢ(j) over j.

$${H}_{i} = - {\sum }_{j = 1 , j \neq 1}^{n} {p}_{i ( j )} {log}_{2} ( {p}_{i ( j )} )$$

This is identical in mathematical form to physical entropy expressions and to Shannon's information expression [2], although the meaning is quite different. After summing on source nodes, the result for the organization's total decision complexity A(n) is:

$$A ( n ) = {\sum }_{i = 1}^{n} {A}_{i} ( n ) = {\sum }_{i = 1}^{n} {A}_{0 i} {H}_{i} \\ = - {\sum }_{i = 1}^{n} {A}_{0 i} {\sum }_{j = 1 , j \neq 1}^{n} {p}_{i ( j )} {log}_{2} ( {p}_{i ( j )} ) \qquad ( 3 )$$

For a particular organization, the probabilities might be determined by field surveys—a major undertaking—or by developing and using a group of standard models.

Equations (1), (2), and (3) can be used as presented above to perform calculations needed in applying the invention, in cases where a detailed description of an organization can be generated at reasonable expense and where the most detailed and accurate estimate is needed.

3. Embodiments of the Method for Performing Calculations

Approximate methods for doing the evaluations are advantageously adopted for use in many instances where organizational productivity is to be modified and where it is acceptable to use the invention for general guidance or where it is too costly or too slow to generate a complete description of the organization suitable for use in the modeling equations (1), (2), and (3). Some of these embodiments are discussed below.

3.1. An Embodiment that Isolates the Organization Structure Form Factor

As a simplifying embodiment, suppose that all of the decision-makers have identical capabilities and that they all work on tasks of the same inherent complexity. The task complexity coefficients Aₒᵢ factor out and can be replaced by a single average A₀. The elementary dit capacities R_{0i,j} likewise factor and are replaced by an average R₀.

$$\begin{matrix}M ( n ) = {M}_{0} \frac{{\sum }_{i = 1}^{n} {\sum }_{j = 1 , j \neq 1}^{n} {ρ}_{i , j}}{- {\sum }_{i = 1}^{n} {\sum }_{j = 1 , j \neq 1}^{n} {p}_{i ( j )} {log}_{2} ( {p}_{i ( j )} )} & ( 4 a ) \\ where {M}_{0} ≡ \frac{{R}_{0}}{{A}_{0}} & \end{matrix}$$

The ratio M₀ is the maximum management decision rate per path due to inherent problem complexity alone, and below the threshold for saturation mentioned earlier. The dimensionless form factor to the right of M₀ depends purely on the organization structure and entropy.

The per capita limit μ(n) on the management decision rate is simply M(n) divided by n, viz:

$$µ ( n ) ≡ \frac{M ( n )}{n} \qquad ( 4 b )$$

This preferred embodiment of the invention advantageously uses the approximate Equations (4a) and 4(b) to avoid the difficulty and expense of quantitatively measuring or evaluating the decision rate coefficient M₀ and/or the coefficients R₀ and A₀. The right hand side of Equation (4a), apart from the overall constant M₀, contains only information about the structure of an organization's decision network, making it useful for isolating the impact of the decision structure on efficiency when the invention is used. Alternative structures may be compared relative to one another, inasmuch as the overall multiplicative coefficient M₀ will cancel out in any ratio of trial structures.

3.2. An Exactly Solvable Embodiment: the Fully Connected Approximation:

In a “fully connected” model all paths between pairs of knowledge workers are open and have equal weighting, with all of the nodes and paths having equal capacities as discussed above. This corresponds to setting ρ_{i,j}=1 for all i and j in Equation (4). This approximation can be solved exactly—all terms in the summations are the same so the sums become trivial—but embodiments of the invention using this approximation tend to overstate the entropy effects. Entropy is a maximum when all choices are equally probable.

In large organizations this model can be applied to individual units or processes that are then sparsely linked to each other.

The maximum dit rate R(n) reduces to simply R₀.n(n−1), which approximates R₀.n² for large n. By assumption also, all of the conditional probabilities pᵢ(j) are equal to 1/(n−1). As a result, the organizational entropy becomes H=n.log₂(n−1) with the decision complexity becoming A(n)=A₀H.

As a check on the n.log₂(n) form found for the entropy, note that that expression is also the combinatorial complexity of the most efficient general method for sorting n objects [5]. The decision network in this particular model can be alternatively viewed as a sorting machine for management decisions each of which has complexity A₀. The entropy is thus proportional to the sorting time.

The maximum sustainable decision rate M(n) for an organization below the size nₛ that triggers saturation is:

$$M ( n ) = {M}_{0} \frac{n - 1}{{log}_{2} ( n - 1 )} \\ \approx {M}_{0} \frac{n}{{log}_{2} ( n )} for large n \leq {n}_{S} \qquad ( 5 a )$$

This result grows sub-linearly—that is, more slowly than n—as is consistent with intuition and previous remarks.

The per capita maximum decision rate μ(n)=M(n)/n is an organization's productivity limit for knowledge-intensive tasks. It declines as 1/log₂(n) as long as the system is below the saturation threshold. If M₀ does not change, the organization can absorb and act on fewer management decisions per person on the average as it grows.

TABLE 1
Form factors for M and μ ignoring

| | | Per Capita |
|---|---|---|
| | Decision Rate | Factor |
| N | N-1/log2(N-1) | 1/log2(N-1) |
| 3 | 2.00 | 1.00 |
| 4 | 1.89 | 0.63 |
| 5 | 2.00 | 0.50 |
| 7 | 2.32 | 0.39 |
| 10 | 2.84 | 0.32 |
| 100 | 14.90 | 0.15 |
| 500 | 56 | 0.11 |
| 1,000 | 100 | 0.10 |
| 10,000 | 753.00 | 0.0753 |
| 100,000 | 6,020 | 0.0602 |
| 200,000 | 11,356 | 0.0568 |
| 500,000 | 24,409 | 0.0528 |
| 1,000,000 | 50,171 | 0.0502 |

log₂(x) = logₑ(x)/logₑ(2) = logₑ(x)/.6931

Table (1) illustrates some relative values of M and μ for a range of sizes for fully connected organizations. For example, a one million-person organization can utilize only about 50,000 times as much management decision capacity as a single individual, neglecting saturation and assuming it is fully connected (the most stressing case).

Above the saturation threshold, the total dit rate is limited by nD₀, where D₀ is the average node's own maximum internal dit capacity that is assumed to be the same for all nodes. If R₀ is made a fixed requirement, the number of nodes that initiates saturation, along with organizational thrashing and productivity implosion, satisfies the equation: D₀=R₀.(nₛ−1). Above the saturation threshold the total decision rate M(n) actually falls as 1/log₂(n) with further growth, due to the increased structural information that adds to the entropy, viz:

$$M ( n ) = {M}_{0} \frac{{n}_{S} - 1}{{log}_{2} ( n - 1 )} \\ \approx {M}_{0} \frac{{n}_{S}}{{log}_{2} ( n )} for large n > {n}_{S} \qquad ( 5 b )$$

The per capita maximum decision rate μ(n) limits individual productivity: it declines as 1/n.log₂(n) in the saturated regime—a factor of n faster than it does below saturation.

This “fully connected” embodiment of the invention allows users to advantageously use the invention without first having to measure individual “dit” capacities for links, inasmuch as Equations (5a) and (5b) depend only on an organization's population and on the overall scale factor M₀ which can be measured experimentally and which cancels in comparative studies.

Figure (1) shows results for μ(n) plotted for organizations whose populations range from 3 nodes to 1 million nodes using the approximations above. Small organizations that grow from a few individuals to

[image]

about 1,000 will experience a ten-fold drop-off in their per capita limiting decision rate that should be highly noticeable. The decrease due to further growth (without saturation) from 10,000 to 100,000 knowledge managers would be only about 20%—smaller but still having significant productivity impact. The contrast would be sudden for a person in a small startup firm that is acquired by a large one. Productivity collapses rather markedly above saturation for any of the choices of nₛ portrayed parametrically.

3.3. An Embodiment that Sparsifies the Topology (Partitions Into Subunits) to Reduce Choice and Entropy

The decision complexity (entropy) is a maximum for the fully connected architecture. An aspect of the invention is the ability to reduce decision complexity by “sparsifying” the decision paths; i.e. by letting some of the coefficients ρᵢⱼ be unequal or zero in Equation (2) or 4(a). This amounts to subdividing an organization into subunits and letting a small fraction of the people do most of the communication between them. The implementations may look like functional silo or independent business unit architectures. The entropy denominator is reduced along with the “dit capacity” numerator in Equation (1). The negative impact on productivity is smaller than for fully connected architectures.

Large organizations have sometimes used sparsification by subdividing into weakly coupled business units or non-hierarchical process teams, often consciously declaring the intent to emulate “small firm environments”. A small fraction only of the knowledge managers interact across these boundaries. However, the invention provides a consistent rationale for selecting when to implement said sparsification in order to reduce decision complexity and quantitative tools for guiding said restructuring toward an improved or optimal solution.

Sparsifying the decision paths may not gain as much efficiency as is hoped for because of the limited capacity of people who have to handle decision interfaces external to the unit. They may need to maintain very high, possibly unsustainable “dit” rates. As an aspect of the invention, individual capability limits Dᵢ for “saturation” (seen in Equation (2) on the extreme right hand side) may replace entropy as a driver, resulting in catastrophically “saturated” functionality as shown in Figure (1).

Partitioning a business tends to decentralize decision-making, making most of it internal to local business units. Excessive sparsification may result in narrow focus and overlooking traditional scale economies, such as those due to common technology and finance. Such complaints are familiar to those who have felt the provincialism in autonomous or weakly coupled organizational units. The traditional functional silo architecture often increases organizational entropy relative to efficient cross-functional processes.

3.4. An Embodiment Using Three Node Organizations to Measure Inherent Problem Complexity Coefficients

M₀ represents the inherent complexity of an organization's tasks with no dependence on organization structure. Once values are measured for particular types of tasks and particular types of individuals performing knowledge management, values of the inherent task complexity can be tabulated and used in models of organizations wherein there are many more than three decision nodes. Embodiments of the invention for organizations with just 3 nodes provide a convenient was of measuring M₀.

Suppose there are just three people in an organization with all of the connections open and equally weighted. As a result, ρ_{i,j}=1 for each of the n(n−1)=6 terms in the double summation of Equation (2). The maximum dit rate is: R(3)=6R₀ dits/unit time.

The decision complexity can be calculated using Equation (3). Any one of the 3 people can select two others as recipients. If all have equal probability of being chosen, pᵢ(j)=½ and log₂(pᵢ(j))=−1 and thus Hᵢ=1; there is just one dit (or bit) of information in this choice since there are 2 destinations. The total organizational entropy given by Equation (3) is H(3)=3, since there are 3 information sources.

The decision complexity A(3)=3A₀ dits/decision. The maximum decision rate therefore becomes simply: M(3)=2M₀ decisions/unit time, using the results above for R(3) and A(3).

Three persons is the smallest organization that can be treated using Equation (1). If n=2 there is no choice of topology for mapping problems onto nodes, pᵢ(j)=1, the entropy function becomes zero, and Equation (4) fails to be mathematically well behaved.

Three person organizations can be used as an experimental tool to measure actual numerical values of the coefficient M₀ by observing said three person workgroups: M₀ it is simply one half of the maximum decision rate observed.

4. Some Qualitative Rules for Managing Entropy

The invention can be used in a less formal embodiment, using a set of rules that may be applied by practitioners of organization reengineering and by senior executives who are trying to improve efficiency in knowledge-dominated organizations. The rules have been used intuitively in the past, but without articulating the connection to a well-defined, quantitative notion of organizational entropy and without benefit of guidance by quantitative measures and structural optimizations made available by use of the invention. These all lower the organizational entropy by increasing the raw decision capacity coefficients R₀ and ρ_{i,j} or by decreasing the decision complexity A(n):
1. Reduce choice by sparsifying structure and improving processes: The invention teaches that limiting choice can reduce the organizational entropy. The decision network should typically not be fully connected as in the idealized model, but it should be sharply pruned to follow defined functions and carry knowledge with known value to the organization.
   Wherever justified, specialized, dedicated work teams should be created. Teaming has the effect of packaging many basic decisions reached by the team into a small number of higher-level decisions, while also constraining much of the interaction to be within the team. A stable workgroup structure reduces choice as colleagues come to understand what is needed from whom without wasted effort. Frequent structural churn that disrupts basic workgroups forces staff to repeatedly learn new sets of relationships and ways of compactly deciding issues.
   Workflow automation reduces choice by controlling knowledge capture and routing automatically across “silo” boundaries directly to the affected decision nodes. Many organizations gain efficiency by restructuring around customer-centric processes. Using automata to automate mundane decision processes reduces the communication volume between expensive humans in the loop and also off-loads some of the decision-making burden.
2. Match organization size to the complexity of the task: Small organizations may have intrinsic competitive advantage for knowledge tasks, but they may be too small to credibly manage large projects. Organizations need to reconfigure periodically in order to match organizational size and structure to the decision complexity of tasks in work. An organization needs critical mass, but not much more if inefficiency is to be avoided. The larger the task, the larger the “entropy” (and hence the lower the unit-person productivity) that must be tolerated and paid for by customers.
3. Build a hierarchy of layered decision meta-languages and decision network layers: Knowledge managers work most efficiently at a level of abstraction wherein many low level decisions are not seen, using “information hiding” principles. Businesses may need different structure for their knowledge-based and facilities-based activities in order achieve efficiencies in both areas. Firms may become internally layered, or evolve layered industry architectures in which the knowledge-management segment splits into small firms or business units.
4. Raise the level of supervisory abstraction: As an organization grows, individuals used to making a large number of fast decisions may overrun the system. Individuals who can work independently and make less frequent but higher-level decisions may avoid that problem. Staff with more abstract thought processes and general rather than direct supervisory styles often have better education and higher compensation; sometimes they appear more detached and less decisive, but may be more effective in a large organization.
5. Use knowledge management systems as a leveler: Information technology is causing the transition to knowledge-based economics and it also provides a potential solution through Knowledge Management Systems (KM systems). KM systems make all of the knowledge possessed by an enterprise accessible wherever it is needed. Three kinds of internal knowledge are often recognized: human knowledge (explicit and tacit), structural knowledge (in records and processes), and customer knowledge. If KM systems in large organizations appear early and are more extensive and effective than those in small organizations they may offset some of the entropy differential. For example, if KM in a 100,000-person firm can provide about 2.5 times the value per decision-maker than in a small 100 person firm the gap disappears.
6. Alter the rewards system to measure and encourage entropy reductions: Managers' rewards often depend on the size of the organizations they supervise and on the their visibility to others. Often this consumes decision-makers' attention with little gain to the organization and the extra decision overhead reduces efficiency.
   5. REFERENCES TO TECHNICAL AND MANAGEMENT LITERATURE
1. Beer, Stafford, Brain of the Firm, Herder & Herder, N.Y., 1972 and later editions, pp. 58-59.
2. Shannon, Claude E. and Warren Weaver: The Mathematical Theory of Communication, University of Illinois Press, 1998, Page 58. Reprinted from an article with the same title in the Bell System Technical Journal of July and October 1948.
3. Tolman, Richard C.: The Principles of Statistical Mechanics, Oxford University Press, 1938, chapter VI.
4. Hamming, Richard W: Coding and Information Theory, Prentice-Hall, 1980, page 101ff.
5. Aho, Alfred V., John E. Hopcroft, & Jeffrey D. Ullman: The design and Analysis of Computer Algorithms, Addison Wesley, 1974, page.77. The sorting literature most often uses base 2 logarithms, which differ from natural logarithms by a factor of logₑ(2)˜0.6921.
6. Amdahl, G. M., “Validity of single-processor approach to achieving large-scale computing capability”, Proceedings of AFIPS Conference, Reston, Va. 1967, page 483-485.

1. Methods or systems that use the organizational entropy and/or the maximum decision rate of an organization, or any function thereof, to measure and/or guide improvements in the efficiency and/or performance of said organization and of individual decision nodes performing knowledge-management activities within said organization.

2. The method or systems of claim 1 wherein said decision nodes of said organization are wholly or partly populated by a plurality of human beings.

3. The method or systems of claim 1 wherein the decision nodes of said organization are wholly or partly populated by a plurality of automated intelligences executing knowledge-management functions that involve decision-making.

4. The methods or systems of claim 1 wherein said organizational entropy and/or said maximum decision rate, or any function thereof, are evaluated in accordance with the definitions, rules, formulas, or recipes taught by the invention.

5. The methods or systems of claim 1 wherein the maximum raw decision item capacity known also as “dit” capacity is calculated in accordance with the definitions, rules, formulas, or recipes taught by the invention, said calculation made for flows of information between pairs of decision nodes of said organization.

6. The methods and processes of claim 5 wherein the calculation of said maximum raw decision item capacity, or any function thereof, incorporates the saturation limits as taught by principles of the invention.

7. The methods or systems of claim 1 wherein said organizational entropy and/or said maximum decision rate, or any function thereof, is incorporated into the cost function or heuristic rule used by a linear or non-linear optimization methodology applied to optimizing or improving performance in said organization.

8. The methods or systems of claim 1 wherein said organizational entropy and/or said maximum decision rate, or any function thereof, is used as a guide for restructuring or reorganizing said organization following “Qualitative rules for managing entropy” taught by the invention.

9. The methods or systems of claim 1 wherein said organizational entropy and/or said maximum decision rate, or any function thereof, is used as a guide for restructuring or reorganizing said organization following practices known to those of ordinary skill in the art of managing and re-engineering organizations.

10. The methods or systems of claim 1 wherein a plurality of or all of said decision nodes are approximated as equivalent to each other, thereby allowing alternative structures to be compared without measuring experimental coefficients.

11. The approximation methods of claim 10 with said approximation described by equations (4a) and (4b) of the embodiment section entitled “Detailed description of the invention”.

12. The methods or systems of claim 10 wherein said organization or subunits thereof is approximated as one or a plurality of “fully connected” organizations, thereby making said structural factor simple to evaluate when evaluating the entropy and maximum management decision rate in accordance with the principles of the invention.

13. The approximation method of claim 11 with said approximation described by equations (5a) and/or (5b) of the embodiment section entitled “Detailed description of the invention”.

14. The methods or processes of claim 1 wherein organizations or groups composed of three persons are used to evaluate the coefficients representing inherent problem complexity and/or the coefficients they depend on.

15. The methods or process of claim 1 wherein the decision channels of said organization are reduced in number and throughput by the process called sparsification in order to reduce the organizational entropy and/or increase the maximum decision rate.
